(19) United States
(12) Patent Application Publication
(10) Pub. No.: US 2026/0277247 A1
(43) Pub. Date: Sep. 17, 2026

(54) EDGE-COORDINATED SENSOR DATA PROCESSING AND HIERARCHICAL VALIDATION SYSTEM

(71) Applicant: Chioccoli LLC, Austin, TX (US)

(72) Inventors: Gregory Daniel Chiocco, Sunnyvale, CA (US); Michael Brogioli, Austin, TX (US)

(73) Assignee: Chioccoli LLC, Austin, TX (US)

(21) Appl. No.: 19/669,893

(22) Filed: May 6, 2026

Related U.S. Application Data
(63) Continuation-in-part of application No. 18/807,970, filed on Aug. 17, 2024.
Application No. 18/807,970 is a continuation of application No. 18/080,411, filed on Dec. 13, 2022, now Pat. No. 12,066,838.
Application No. 18/080,411 is a continuation of application No. 17/578,408, filed on Jan. 18, 2022, now Pat. No. 11,526,180.
Application No. 17/578,408 is a continuation-in-part of application No. 17/306,839, filed on May 3, 2021, now Pat. No. 11,354,757.
Application No. 17/306,839 is a continuation-in-part of application No. 17/060,025, filed on Sep. 30, 2020, now Pat. No. 11,750,701.
(60) Provisional application No. 62/907,727, filed on Sep. 30, 2019.
(60) Provisional application No. 63/801,591, filed on May 7, 2025.

(51) Int. Cl. G05D 1/695; B64C 39/02; B64U 10/13; B64U 101/00; B64U 101/20; B64U 101/30; B64U 101/40

(52) U.S. Cl. CPC G05D 1/695; B64C 39/024; B64U 10/13; B64U 2101/00; B64U 2101/20; B64U 2101/30; B64U 2101/40; B64U 2201/10

(57) ABSTRACT

An edge computing device in a multi-tier sensor network computes per-region novelty scores by integrating anomaly detection outputs, training distribution gap metrics, and external contextual data, and transmits sensing directives that cause mobile sensor platforms to physically reposition to prioritize high-novelty regions. Sensor nodes perform local anomaly pre-screening and optional peer-to-peer corroboration before transmitting indicators to the edge device. The edge device validates detected events through determination within spatial-temporal trigger windows, applying cross-modal weighting and temporal integration. A model patching engine applies incremental parameter updates to running inference models without service interruption, with automated checkpoint and rollback restoring prior model parameters when post-patch validation detects performance degradation. Validated events and parameter deltas are selectively transmitted to a cloud server for global model retraining and redistribution.

### CROSS-REFERENCE TO RELATED APPLICATIONS

This application is also a continuation-in-part application of U.S. Non-Provisional application Ser. No. 18/807,970 filed Aug. 17, 2024, which is a continuation of U.S. Non-Provisional patent application Ser. No. 18/080,411, filed on Dec. 13, 2022, which is a continuation of U.S. Non-Provisional patent application Ser. No. 17/578,408, filed on Jan. 18, 2022, which is a continuation-in-part of U.S. Non-Provisional patent application Ser. No. 17/306,839 filed on May 3, 2021, which is a continuation-in-part of U.S. Non-Provisional patent application Ser. No. 17/060,025 filed on Sep. 30, 2020, which claims priority to U.S. Provisional Patent Application Ser. No. 62/907,727, titled “SYSTEMS AND METHODS FOR CONNECTED COMPUTATION IN NETWORK CONSTRAINED SYSTEMS,” filed on Sep. 30, 2019, the disclosure of which is hereby incorporated by reference in its entirety.

This application also claims priority to U.S. Provisional Patent Application Ser. No. 63/801,591, titled “GENERALIZED, HIERARCHICAL, MULTIMODAL EVENT DETECTION,” filed on May 7, 2025. All applications are hereby incorporated by reference in their entirety.

### BACKGROUND

### Field of the Art

The present disclosure is related to the field of edge computing-based intelligent surveillance systems, and more particularly to systems and methods for dynamically orchestrating mobile sensor platforms using adaptive anomaly detection, multi-sensor spatiotemporal corroboration for false alarm suppression, and on-device incremental model updating with autonomous rollback capabilities.

### Discussion of the State of the Art

Distributed sensor monitoring systems are deployed across a range of applications including infrastructure inspection, environmental surveillance, and industrial asset management. These systems typically comprise networks of fixed and mobile sensors—including cameras, drones, and various environmental detectors—that collect data from spatially distributed locations and transmit it to processing centers for analysis. A persistent problem with such systems is the generation of large volumes of redundant and uninformative data. For example, a drone surveying a pipeline corridor may capture thousands of image frames depicting normal conditions while the single frame containing evidence of a defect occupies a negligible fraction of the total data collected. This indiscriminate data capture consumes network bandwidth, storage resources, and downstream processing capacity. It also imposes a burden on human reviewers who must sift through predominantly irrelevant data to locate actionable information. Conventional approaches have attempted to mitigate this problem through post-hoc filtering, in which all sensor data is first transmitted to centralized servers and then subjected to filtering algorithms. However, this method is inherently inefficient because the redundant data has already consumed transmission and storage resources by the time filtering is applied. The underlying architecture remains passive: sensors capture and transmit data without regard to its informational value, and the system lacks the ability to autonomously direct sensor resources toward regions or events of higher relevance.

A related deficiency in existing monitoring architectures is the absence of mechanisms for autonomous detection validation and evidence gathering. When a sensor flags a potential anomaly, conventional systems either apply a fixed threshold to generate an alert or queue the flagged event for manual human review. Some systems implement voting schemes among networks of homogeneous sensors, but these schemes are static, operating with predetermined agreement thresholds that do not adapt to changing environmental conditions. Moreover, such voting approaches are generally limited to sensors of the same type and do not support cross-modal corroboration—for instance, correlating a thermal anomaly detected by one sensor with a visual observation from another sensor type. The architectural topology of existing systems further compounds this problem. Fully centralized architectures create bandwidth bottlenecks and introduce latency between detection and response. Fully decentralized or flat architectures, in which each sensor operates in isolation, lack any mechanism for collaborative validation, resulting in elevated false positive rates. No effective intermediate architectural tier exists in current systems to enable localized, collaborative assessment of detections among nearby or functionally related sensors without requiring all data to traverse the network to a central processing point.

Path planning for mobile sensors such as drones has been addressed in prior work through algorithms that optimize for geographic coverage area or minimize total travel distance. These approaches treat all regions within the survey area as having equal information value, which leads to uniform sampling patterns that do not concentrate sensing effort on areas where anomalies are more likely or where prior observations are ambiguous. Active learning techniques, which select data samples that would be most informative for model training, have been developed in the machine learning literature, but these techniques operate offline during batch training cycles rather than directing the physical movement of sensors in real-time field operations. Separately, machine learning models deployed on edge devices in field environments are subject to performance degradation over time as environmental conditions, lighting, weather, and the physical state of monitored assets change. Current model maintenance practices follow conventional MLOps workflows designed for data center environments: data is collected and transmitted to cloud servers, models are retrained in batch processes, subjected to human approval gates, and then redeployed to edge devices. This cycle can span days to weeks, during which the degraded model continues to operate with outdated parameters. These retraining workflows assume reliable network connectivity and human oversight, assumptions that do not hold for resource-constrained edge devices operating autonomously in remote or connectivity-limited field settings. Incremental or in-situ model adaptation at the edge remains unaddressed by these conventional approaches.

### SUMMARY

The present disclosure relates to a multi-tier distributed monitoring system, and to corresponding methods and edge computing devices, for event determination across a monitored environment. The system comprises a plurality of field-deployed sensor nodes, each having one or more sensing instruments and a local processing unit configured to perform pre-screening and to transmit pre-screening indicators upon identifying candidate events; an edge computing device coupled to the sensor nodes and configured to apply a determination criterion to corroborating pre-screening indicators received within an evaluation window in order to confirm trigger events; and one or more remote computing systems coupled to one or more edge computing devices and configured to aggregate event records and parameter changes received from the edge computing devices.

In the disclosed architecture, the edge computing device computes a per-region novelty score for each of a plurality of regions of the monitored environment by integrating at least two of: an output of an anomaly detection module indicating deviation from a previously characterized pattern; a metric indicating a statistical distance between data received from the region and a stored representation of a training distribution of a model maintained on the edge computing device; and contextual data received from a data source external to the edge computing device. The edge computing device transmits a sensing directive to at least one sensor node based on the per-region novelty scores, causing the sensor node to physically reposition to prioritize data collection in regions of higher per-region novelty over regions of lower per-region novelty. By coupling computed novelty to the physical movement of sensor nodes, the system actively shapes its own data collection in advance of detection events rather than relying on uniform or randomized survey patterns followed by centralized post-processing.

When pre-screening indicators are received from two or more sensor nodes within the evaluation window, the edge computing device applies a determination criterion requiring that a configured threshold number of sensor nodes report corroborating pre-screening indicators before confirming a trigger event. The determination criterion may further comprise a weighting that assigns greater validation weight to corroboration between sensor nodes whose sensing modalities differ in physical principle of transduction, operational frequency band, or sensed measurand, than to corroboration between sensor nodes of the same modality. The pre-screening performed by individual sensor nodes may include time-domain, frequency-domain, distance-metric, temporal, or spectral analyses; in particular, a sensor node may identify a candidate event when a sensed condition that would not constitute a candidate event during a stored expected time window is observed outside that time window, or when a computed spectral signature of an observed object deviates from a stored reference spectral signature by more than a stored threshold. Sensor nodes may further engage in preliminary corroboration with neighboring sensor nodes via a wireless inter-node link prior to transmitting pre-screening indicators to the edge computing device. To address physical occlusion of monitored assets, the edge computing device may coordinate multiple sensor nodes to observe a common asset from spatially diverse orientations and fuse the observations into a composite representation.

The edge computing device maintains the model in a manner that preserves model integrity across successive updates. Prior to applying an update, the edge computing device writes a checkpoint of model parameters to a storage; following application of the update, the edge computing device validates the updated model against data buffered on the edge computing device and, responsive to a performance metric of the updated model failing to satisfy a stored threshold, restores the model parameters from the checkpoint without requiring communication with the remote computing system. During periods of constrained, intermittent, or absent connectivity to the remote computing system, the edge computing device may compute and apply local model upgrades subject to the same checkpoint-then-validate-then-restore protocol, and may defer transmission of parameter changes representative of the local upgrades to the remote computing system until connectivity is restored. The model may further support a deterministic execution mode in which one or more parameters governing stochastic aspects of inference are fixed such that successive inferences over identical input data produce identical output, supporting auditable reasoning and certification workflows. The edge computing device may further write to the storage an audit log identifying, for each confirmed trigger event, each sensor node that contributed a corroborating pre-screening indicator and a value of each such indicator, and identifying, for each restoration of model parameters from a checkpoint, the performance metric value that triggered the restoration and the rejected update.

The disclosed architecture provides improvements over monitoring approaches that rely on uniform or randomized data acquisition followed by centralized post-processing. Coupling computed novelty to physical sensor repositioning reduces redundant data acquisition and the associated transmission, storage, and review costs. The hierarchical determination of trigger events at the edge tier reduces false positive rates relative to single-sensor threshold-based detection while reducing wide-area network bandwidth consumption by transmitting only event records and parameter changes rather than raw sensor streams. The checkpoint-then-validate-then-restore protocol prevents degraded model updates from persisting in operational deployments without manual intervention, and the deferred-upload behavior during constrained connectivity enables continuous on-device improvement of the model in remote, mobile, or otherwise bandwidth-limited environments.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates a network architecture comprising a cloud server system, edge computing device, mobile sensor platforms, stationary sensor nodes, external data source interface, and user devices.

FIG. 2 illustrates the internal subsystem architecture of the edge computing device.

FIG. 3A illustrates a process for continuous sensing, detection, and event validation.

FIG. 3B illustrates a process for model update and cloud synchronization.

FIG. 4 illustrates one embodiment of the computing architecture that supports an embodiment of the inventive disclosure.

FIG. 5 illustrates components of a system architecture that supports an embodiment of the inventive disclosure.

FIG. 6 illustrates components of a computing device that supports an embodiment of the inventive disclosure.

FIG. 7 illustrates components of a computing device that supports an embodiment of the inventive disclosure.

### DETAILED DESCRIPTION

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

### Network Architecture

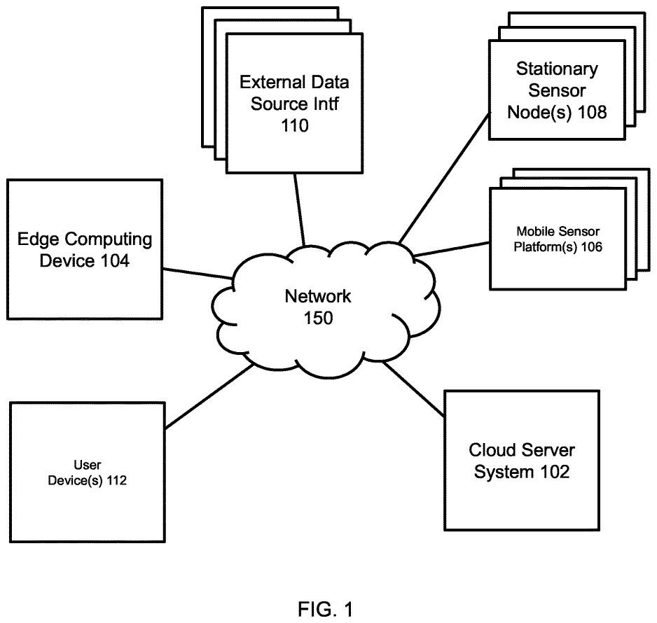

FIG. 1 illustrates an exemplary embodiment of an Edge-Coordinated Sensor Data Processing and Hierarchical Validation System. The system comprises a cloud server system 102, an edge computing device 104, one or more mobile sensor platforms 106, a plurality of stationary sensor nodes 108, an external data source interface 110, and one or more user devices 112, communicatively coupled via a network 150. The system is organized as a multi-tier architecture in which the stationary sensor nodes 108 and mobile sensor platforms 106 form a sensor tier responsible for data acquisition and local anomaly pre-screening, the edge computing device 104 forms an intermediate processing tier responsible for novelty assessment, event validation, sensing orchestration, and local model management, and the cloud server system 102 forms a centralized tier responsible for global model training, system-wide data aggregation, and model distribution.

Although for clarity of illustration the system 100 is depicted with a single edge computing device 104, the system 100 may comprise a plurality of edge computing nodes (also referred to herein as edge computing devices), each edge computing node being communicatively coupled to a respective subset of the plurality of field-deployed sensor nodes, to the cloud server system 102, or to both. The plurality of edge computing nodes may operate in parallel, each independently performing the novelty assessment, event determination, model maintenance, and resource-aware workload partitioning functions described herein for its respective subset of sensor nodes; or in coordination with one another, exchanging pre-screening indicators, sensing directives, model checkpoints, or aggregated event records over the network 150 or over a dedicated inter-edge link, without requiring transit of such information through the cloud server system 102. References herein to “the edge computing device 104” or “the edge computing device” are to be construed as references to “at least a first edge computing node of the plurality of edge computing nodes,” and the descriptions of the functional modules of the edge computing device 104 apply equally to any one or more of the plurality of edge computing nodes.

The cloud server system 102 comprises one or more remote computing servers communicatively coupled to the edge computing device 104 via a wide-area network. The cloud server system 102 receives, aggregates, and processes event data and parameter deltas transmitted from a plurality of geographically dispersed edge computing devices across the distributed monitoring network. The cloud server system 102 includes a global model training engine that collects parameter deltas representing incremental updates to local model weights computed at each edge computing device, combines these deltas with processed event data to produce a consolidated training dataset reflective of conditions observed across the network, retrains one or more machine learning models using the aggregated dataset, and validates the retrained models against held-out test data. Upon successful validation, the cloud server system 102 assigns version identifiers to the validated models and stores both current and prior model versions in a model repository, enabling rollback to earlier versions if a deployed model exhibits degraded field performance. The cloud server system 102 transmits updated global models to the edge computing devices for local deployment. The wide-area network coupling the cloud server system 102 to the edge computing devices may be implemented using the public internet, a private virtual network, a software-defined wide-area network, or a satellite link. The global model training engine may employ federated averaging or secure aggregation protocols when aggregating parameter deltas from the edge computing devices.

The edge computing device 104 comprises a processor, memory, non-volatile storage, and a network interface, and operates as the intermediate processing tier between the sensor nodes and the cloud server system 102. The edge computing device 104 receives sensor data streams from the plurality of sensor nodes over a local-area or mesh network and performs localized computation to reduce latency, bandwidth consumption, and dependency on continuous cloud connectivity. The edge computing device 104 executes novelty assessment computations on incoming sensor data to generate sensing directives that are transmitted to the mobile sensor platforms, enabling adaptive data collection in the field without requiring round-trip communication to the cloud server system. The edge computing device 104 performs hierarchical voting logic to validate detected events within defined spatial-temporal trigger windows, such that only events corroborated by multiple sensor inputs within a prescribed geographic region and time interval are promoted for further processing or transmission.

The edge computing device 104 maintains locally-stored machine learning models and applies lightweight model patches—implemented as delta weight updates, quantized parameter adjustments, or adapter layers—to update those models without requiring full retraining or complete model replacement. The edge computing device 104 maintains a model checkpoint in non-volatile storage enabling automated rollback to a prior model state if a newly applied patch degrades inference performance. The edge computing device 104 also maintains a recent data buffer comprising a sliding window of recently received sensor data, which is used for post-patch validation to confirm acceptable inference results before the patched model is committed for ongoing use. Upon successful validation of detected events through the hierarchical voting logic, the edge computing device 104 selectively transmits only validated event data and model deltas to the cloud server system, conserving upstream bandwidth by filtering information prior to cloud ingestion.

The edge computing device 104 implements a resource-aware workload partitioning function that governs allocation of processing tasks between local execution on the edge computing device 104 and offloading to the cloud server system 102. The resource-aware workload partitioning function evaluates current processing load on the edge computing device, available bandwidth on the link between the edge computing device and the cloud server system, expected round-trip latency for cloud processing, and energy consumption constraints applicable to the edge computing device or the sensor nodes under its management. Based on the evaluation of these factors, the edge computing device 104 determines in real time whether a given analytical task—such as event classification, event characterization, or model inference—should be executed locally or transmitted to the cloud server system for processing, such that the overall resource expenditure across the distributed monitoring network is minimized.

The edge computing device 104 maintains model update trigger conditions governing when the locally-stored machine learning model is subjected to retraining or patching. The trigger conditions include a scheduled retraining event at a predetermined interval, the model producing confidence scores below a threshold for a predetermined number of consecutive inferences indicating sustained degradation, or accumulation of a threshold number of validated trigger events within a specified period indicating that the operational environment has shifted sufficiently to warrant model revision. In alternative embodiments, the edge computing device 104 may comprise an FPGA or ASIC in addition to or in place of a general-purpose processor for accelerating novelty assessment and inference tasks.

The mobile sensor platform 106 comprises an autonomous or semi-autonomous vehicle equipped with one or more sensing instruments, an onboard processor, a wireless communication interface, and a navigation system. The mobile sensor platform 106 may be embodied as an unmanned aerial vehicle, a ground-based robotic platform, a waterborne autonomous vessel, or a repositionable camera system. The sensing instruments may include multispectral or hyperspectral imaging sensors, LiDAR scanners, acoustic transducers, thermal infrared cameras, or combinations thereof.

The mobile sensor platform 106 receives sensing directives from the edge computing device 104 specifying modified flight paths, adjusted priority queues, updated sampling schedules, or revised waypoint sequences. Upon receipt, the mobile sensor platform 106 physically repositions to prioritize data collection in regions the edge computing device has identified as exhibiting high novelty. Repositioning may involve deviating from a pre-programmed survey route, adjusting altitude or standoff distance, increasing dwell time over a designated region, modifying sensor orientation, or altering the temporal sampling rate for a geographic zone. Prior to transmission, the mobile sensor platform 106 may perform preliminary signal processing including frequency-domain analysis, distance-metric comparisons against stored reference signatures, or feature extraction that reduces raw readings to compact descriptor vectors. The stored reference signatures may be periodically updated by the edge computing device 104 to reflect evolving baseline conditions.

The stationary sensor node 108 comprises a fixed-position sensing device deployed at a predetermined location within the monitored environment, including one or more sensing instruments such as vibration sensors, acoustic sensors, thermal sensors, or imaging devices, a local processing unit, memory, and a wireless communication interface. The anomaly pre-screening performed by the local processing unit is a defining property of the sensor tier: rather than operating as passive data collectors that transmit all readings indiscriminately, the stationary sensor nodes 108 evaluate their own readings locally and transmit pre-screening indicators and selectively filtered data to the edge computing device 104.

The local processing unit of the stationary sensor node 108 performs frequency-domain analysis via Fast Fourier Transform and spectral decomposition, and executes distance-metric comparisons between current data windows and stored normal-operation reference signatures using Hamming distance, cosine similarity, or Mahalanobis distance. When the computed distance metric remains below a configured threshold, the stationary sensor node 108 transmits only compressed summaries or extracted feature vectors. Upon detecting an anomaly—a distance metric exceeding the threshold—the stationary sensor node 108 transitions to a full data burst transmission mode. In alternative embodiments, the distance-metric comparisons may employ Euclidean distance, Kullback-Leibler divergence, or dynamic time warping distance. The frequency-domain analysis may alternatively employ wavelet transforms or Hilbert-Huang transforms.

In some embodiments, the local processing unit of a sensor node, or the edge computing device, is configured to identify a candidate event based on a temporal characteristic of an observed condition, even where the observed condition by itself would be considered nominal. For each of one or more sensed conditions, the local processing unit, or the edge computing device, maintains a stored expected time window during which the sensed condition is considered nominal—for example, a time-of-day range during which a particular asset is expected to be operational, a calendar interval during which inventory turnover is expected, or a periodic schedule during which authorized personnel or vehicles are expected to be present in a monitored area. When the sensed condition is observed outside the stored expected time window, the local processing unit generates a pre-screening indicator identifying the condition as a candidate event, notwithstanding that the same observed condition occurring within the stored expected time window would not have generated a pre-screening indicator. By way of example and not limitation, the presence of a vehicle in a loading dock during normal business hours may be suppressed as nominal, while the presence of the same vehicle in the same location at a time outside normal business hours is reported as a candidate event. The stored expected time windows may be configured manually, learned from historical observation data, or periodically updated by the edge computing device based on operational patterns observed across the monitored environment.

In some embodiments, the local processing unit of a sensor node is configured to perform spectral pre-screening of imagery or other electromagnetic sensor data. The local processing unit acquires sensor data spanning two or more wavelength bands—including, by way of example and not limitation, a visible-light color channel set, a multispectral set including one or more near-infrared or short-wave infrared bands, or a hyperspectral set comprising tens or hundreds of contiguous narrow bands—and computes a spectral signature characterizing the spectral content of an observed object or region. The spectral signature may take the form of a reflectance vector, a normalized band-ratio vector, a vegetation index (such as NDVI or its variants), a chlorophyll- or pigment-related index, a thermal-emissivity vector, or any combination thereof. The local processing unit compares the computed spectral signature against one or more stored reference spectral signatures associated with expected conditions, computing a deviation metric using a distance function such as spectral angle mapper, Euclidean distance, Mahalanobis distance, or Kullback-Leibler divergence. Where the deviation metric exceeds a stored threshold, the local processing unit generates a pre-screening indicator identifying the observation as a candidate event. By way of example and not limitation, an agricultural deployment may treat a crop of the expected species but exhibiting a spectral signature indicative of nutrient stress, water stress, or disease as a candidate event, even though the visible morphology of the crop appears nominal; an industrial deployment may treat a thermal-emissivity signature departing from a stored reference for an asset class as a candidate event indicative of incipient equipment failure. The stored reference spectral signatures may be configured manually, derived from supervised training data, or updated by the edge computing device as new validated observations are accumulated.

The sensor nodes within the system may comprise a heterogeneous population with varying computational capabilities, memory capacities, and communication bandwidth. For example, a mobile sensor platform embodied as a drone equipped with a multiprocessor system-on-chip and substantial onboard storage represents a high-capability node, whereas a fixed moisture sensor or low-frame-rate camera with a microcontroller represents a low-capability node. The edge computing device 104 may configure different pre-screening algorithms, anomaly detection thresholds, sampling rates, and data transmission profiles for different tiers of sensor nodes based on their respective processing resources. High-capability nodes may execute more computationally intensive pre-screening operations such as frequency-domain analysis, multi-feature distance metric comparisons, or lightweight neural network inference, while low-capability nodes may be limited to simple threshold comparisons or single-metric deviation checks. The edge computing device 104 maintains a capability profile for each registered sensor node in its configuration data, and may dynamically adjust pre-screening assignments as nodes join or leave the network or as operational conditions change.

In certain embodiments, the stationary sensor nodes 108 and mobile sensor platforms 106 support peer-to-peer communication with neighboring sensor nodes via short-range wireless links, enabling collaborative assessment at the sensor tier prior to transmission of pre-screening indicators to the edge computing device 104. When a sensor node detects a candidate event, it may broadcast a short-range alert (also referred to herein as a wireless inter-node alert) to neighboring nodes within communication range. Neighboring nodes receiving the alert evaluate their own recent readings for corroborating evidence and respond with an indication of whether corroboration was observed. The originating node includes in its pre-screening indicator transmitted to the edge computing device information indicating whether any neighbors provided preliminary corroboration, enabling the edge to incorporate sensor-tier corroboration into its determination. This preliminary validation reduces the volume of isolated, uncorroborated indicators transmitted to the edge.

The plurality of stationary sensor nodes 108 within the coverage area of an edge computing device 104 may be organized into one or more spatial clusters, each comprising sensor nodes that are geographically proximate or functionally related—for example, nodes monitoring the same pipeline segment, agricultural zone, or facility area. The clustering configuration is maintained in configuration data on the edge computing device 104 and may be defined based on geographic proximity, infrastructure topology, or operational zone designations. The edge computing device 104 applies its determination independently per cluster, such that an anomaly is confirmed for a given cluster when the threshold number of nodes within that cluster report corroborating indicators, regardless of whether nodes in other clusters have reported events. Per-cluster validation enables different effective sensitivity levels across zones and prevents localized anomalies from being diluted by normal readings from distant sensors.

The external data source interface 110 comprises a network gateway and a data normalization engine that retrieve, ingest, and process contextual data from external systems including weather data feeds, public infrastructure databases, satellite imagery services, and environmental monitoring systems. The data normalization engine transforms heterogeneous formats, coordinate systems, temporal encodings, and measurement units into a standardized schema compatible with the novelty assessment engine on the edge computing device. The external contextual data serves as one of three input signals to the novelty assessment, the other two being derived from the sensor platforms and from internally maintained training distribution representations. In alternative embodiments, the external data source interface 110 may be implemented as a publish-subscribe message broker or as a federated query engine executing distributed queries across the external sources.

User devices 112 include computing devices such as laptops, tablets, or smartphones configured to communicate over the network 150 and to present monitoring information, event notifications, model status reports, and annotation queues to human operators or data engineers. User devices 112 may execute applications providing interfaces for reviewing validated events, configuring system parameters such as quorum thresholds, trigger window durations, and cluster boundaries, and reviewing data segments routed for human annotation.

Network 150 represents a network or collection of networks over which the components of FIG. 1 communicate. Network 150 may be an intranet, VPN, LAN, WLAN, WAN, a portion of the Internet, or a combination thereof. One or more wired, wireless, or optical links couple the systems described herein to the network 150.

The system may contain other subsystems and databases not illustrated in FIG. 1 but readily apparent to a person of ordinary skill in the art, including databases for storing data, features, training sets, and models. Other databases and systems may be added or subtracted without departing from the scope of the invention.

The terms used herein are intended to be construed broadly. A “sensor node” refers to the data-acquisition device or instrument package that performs measurement and local pre-screening, whereas an “edge computing device” refers to a separate, locally-hosted compute unit (for example, a multicore processor system running a general-purpose operating system) that aggregates inputs from one or more sensor nodes; the two are distinct in function and may be physically separate. The “cloud server system” is not limited to any particular deployment topology and may be embodied as one or more remote computing systems, a compute farm, a data center, a colocation facility, a virtualized fabric distributed across multiple geographic regions or providers, or any combination thereof; in some embodiments the global model training is performed on compute resources that are operationally separate from the compute resources used to serve inference, including third-party data centers or colocation facilities. A monitoring deployment may include a plurality of edge computing devices and a plurality of cloud server systems. Communication between the sensor tier, the edge tier, and the cloud tier may use any wired, wireless, or optical link, including without limitation Ethernet, Wi-Fi, low-bandwidth cellular (e.g., LTE-M, NB-IoT), broadband cellular (e.g., 4G, 5G), mesh radio, satellite, and combinations thereof; one edge computing device may also act as a relay or broker for traffic between other edge computing devices or sensor nodes. Mobile sensor platforms need not be dedicated survey vehicles; a sensor platform may be a component of a separate automated system performing tasks unrelated to anomaly monitoring (such as a delivery drone, an agricultural implement, or a fleet vehicle), with sensing performed opportunistically. The system may further apply geofencing constraints to sensing directives and platform movement, such that high-novelty regions are pursued only when the platform remains within a configured geographic boundary, and may apply temporal constraints to event determination such that an observed condition is treated as an event when the observation occurs outside an expected time window for that condition (for example, equipment present in the correct location but at the wrong time). Computer-vision-based pre-screening may include color-space, multispectral, or hyperspectral comparisons in which deviation in the spectral signature of an observed object from a stored reference signature constitutes a candidate event (for example, a crop of the expected species but exhibiting a shade or spectral pattern indicative of disease or stress). The “model” referenced in the claims need not be a machine learning model; in alternative embodiments the model may be a deterministic rules-based model, a statistical model, or a hybrid system. Where a machine learning model is used, the model may be configured to operate in a deterministic execution mode by fixing parameters such as sampling temperature and pseudo-random seed values to support repeatable training, validation, audit, and certification workflows. In connectivity-constrained deployments, the edge computing device may perform on-device incremental training and apply locally-derived model upgrades subject to the same checkpoint-then-validate-then-rollback protocol described herein, deferring upload of the resulting parameter changes to the cloud server system until connectivity is restored. The term “anomaly” as used in this disclosure is intended to encompass any event of interest that the system is configured to identify, including events that are predicted, scheduled, expected, or routine; the use of “anomaly” elsewhere in the disclosure or claims should not be construed to require that the event be unexpected.

Further terminology equivalences. The following terms are used interchangeably herein and the use of any one such term is to be construed as a reference to all of them: “event validation,” “event determination,” and “anomaly detection” each refer to the process by which the edge computing device confirms or rejects a candidate event reported by sensor nodes; “anomaly indicator” and “pre-screening indicator” each refer to the message or data structure transmitted by a local processing unit of a sensor node reporting that the local processing unit has identified a candidate event; “trigger window,” “integration time window,” “spatial-temporal trigger window,” and “evaluation window” each refer to the time interval during which the edge computing device aggregates pre-screening indicators from sensor nodes for purposes of confirming a trigger event; “determination criterion,” “X-of-Y voting threshold,” and “determination criterion” each refer to the rule applied by the edge computing device to determine whether a sufficient number of sensor nodes have reported corroborating pre-screening indicators within the evaluation window for the trigger event to be confirmed; “cloud server system,” “remote computing system,” and “remote computing fabric” each refer to one or more computing systems that are remote from the edge computing device and that aggregate event records, parameter changes, or both, from one or more edge computing devices; and “short-range wireless link” and “wireless inter-node link” each refer to a wireless communication path between sensor nodes that does not require transit through the edge computing device. The intent of these equivalences is to make explicit that variations in terminology between this disclosure and the appended claims, and between different portions of the disclosure or claims, are not to be construed as introducing distinct elements.

The terms “model,” “local model,” “local analytical model,” “analytical model,” “machine learning model,” and “locally-deployed machine learning model” as used in this disclosure and in the appended claims are interchangeable and each refer to any analytical model maintained on or executed by the edge computing device, including without limitation a machine learning model (such as a neural network, decision tree ensemble, gradient-boosted model, or support vector model), a statistical model, a deterministic rules-based model, a hybrid model combining two or more of the foregoing, or any other algorithmic representation that maps received sensor data to one or more output values, classifications, or decisions. The hierarchical designations “local instance” of the model, “updated local instance” of the model, and “global model” or “globally-aggregated model” refer to the same model at different stages of its lifecycle (locally executed, locally updated and pending validation, and aggregated across the plurality of edge computing devices, respectively), and any of these designations may be referred to herein simply as “the model” without limitation.

### System Architecture

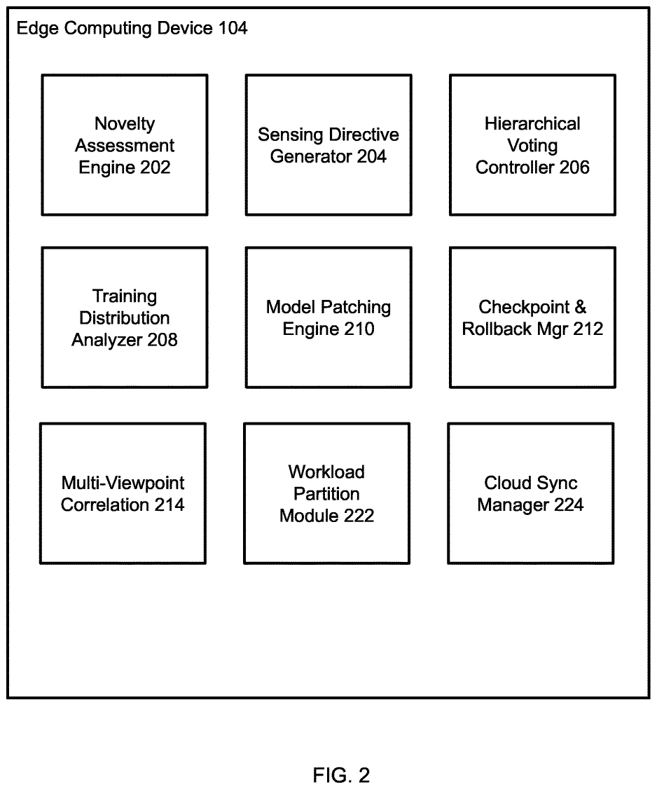

FIG. 2 illustrates the internal subsystem architecture of the edge computing device 104. The various components described herein are exemplary and any combination or subcombination may be used as would be apparent to one of ordinary skill in the art.

The Novelty Assessment Engine 202 is a computational module executed by the processor of the edge computing device, configured to compute a novelty score for each discrete region within the monitored environment. The Novelty Assessment Engine 202 receives heterogeneous input signals from upstream components and synthesizes them into per-region novelty metrics that inform the Sensing Directive Generator 204 about which regions warrant modified or intensified sensing attention.

The Novelty Assessment Engine 202 receives and integrates at least two of three distinct input signal types. A first type comprises anomaly model outputs from an anomaly detection module, encoding deviation magnitudes representing how substantially observed data departs from previously characterized patterns. A second type comprises training distribution gap metrics from the Training Distribution Analyzer 208, quantifying statistical divergence between incoming data and the distribution upon which the machine learning models were trained. A third type comprises external contextual data from the external data source interface 110, including environmental metadata, geospatial intelligence feeds, or domain-specific reference datasets. Integration of at least two of these three constitutes the minimum operational requirement, though all three may be simultaneously ingested. The Novelty Assessment Engine 202 applies weighted combination functions—linear weighted sums, nonlinear mapping functions, or multiplicative fusion operators—to produce a per-region novelty score. The weighting coefficients may be statically configured, dynamically adjusted based on operational context, or learned through a trained neural network that maps the input signal space to novelty outputs.

The Novelty Assessment Engine 202 maintains a configurable exploration ratio parameter governing allocation of sensing resources between high-novelty regions and regions whose scores fall below the directive threshold. The exploration ratio specifies a minimum fraction of sensing directives allocated to low-novelty regions, ensuring that gradual drift or slow-developing anomalies in stable areas are not indefinitely neglected. The exploration ratio may be fixed, periodically adjusted based on the rate of recent novel discoveries, or dynamically modulated by a reinforcement-learning-based scheduler balancing information gain against undetected-change risk.

The Novelty Assessment Engine 202 applies a temporal decay function to per-region novelty scores, such that the score of a region increases as elapsed time since its most recent observation grows and decreases upon receipt of new observations. In one embodiment, the function implements an inverse exponential decay parameterized by a configurable half-life, while regions exceeding a staleness threshold receive a scaling term that progressively inflates their scores. The decay rate and staleness threshold may be configured globally, per region type, or per asset criticality level. The temporal decay is applied after the weighted signal combination and before scores are transmitted to the Sensing Directive Generator 204.

The Novelty Assessment Engine 202 further computes a per-segment novelty score for individual captured data segments—such as image frames, time-series windows, or point cloud scans—quantifying informational value relative to the existing training corpus. Segments falling in low-density regions of the training distribution feature space receive higher scores. Based on these scores, the edge computing device routes segments exceeding a configurable annotation threshold to a human annotation queue for manual labeling, while segments below the threshold are auto-labeled using the current model's inference output or discarded. The annotation threshold may be fixed, adaptive based on available annotation capacity, or derived from a function balancing annotation cost against expected model improvement.

The Sensing Directive Generator 204 is a software module that transforms novelty scores and spatial metadata into actionable instructions for mobile sensor platforms. The Sensing Directive Generator 204 maintains a state representation of current platform positions, operational constraints, and mission parameters, and reconciles these against incoming novelty data to produce directives that are spatially coherent and operationally feasible.

The Sensing Directive Generator 204 receives novelty scores associated with geospatial coordinates or region identifiers and produces output instructions of at least one of several types. A first type comprises modified flight paths specifying waypoint sequences prioritizing high-novelty regions, with ordering determined through greedy heuristics, traveling salesman approximations, or weighted graph traversal. A second type comprises priority queues ranking locations by novelty score for sequential visitation. A third type comprises sampling schedules adjusting collection frequency, dwell time, or measurement resolution per region. The generator may produce any combination concurrently and tailor type selection to each platform's capabilities and bandwidth. The generator incorporates the exploration ratio from the Novelty Assessment Engine 202 such that the configured minimum fraction of directives target low-novelty regions.

The Sensing Directive Generator 204 formats directives into structured data representations and transmits them to mobile sensor platforms via the network interface. In alternative embodiments, the directive generation logic may employ multi-objective optimization frameworks balancing novelty-driven exploration against energy consumption, airspace deconfliction, and temporal coverage requirements.

The validation of a candidate event by the Hierarchical Voting Controller 206 may proceed via “cross-modal” consensus, “intra-modal” consensus, or a combination of both. Cross-modal consensus, also referred to herein as “cross-modal agreement” or “cross-modal corroboration,” refers to corroboration between two or more sensor nodes whose sensing modalities differ in at least one of physical principle of transduction, operational frequency band, or sensed measurand. Intra-modal consensus, also referred to herein as “intra-modal agreement,” “intra-modal corroboration,” or “same-modality agreement,” refers to corroboration between two or more sensor nodes whose sensing modalities are identical in each of those characteristics. The Hierarchical Voting Controller 206 may assign greater validation weight to cross-modal consensus than to intra-modal consensus, may treat the two forms of consensus as alternatives that independently satisfy the determination criterion, or may combine the two by accumulating partial validation credit from each toward a configured aggregate threshold.

The Hierarchical Voting Controller 206 is a software module that validates detected events through multi-sensor corroboration, operating as a decision layer between sensor-level anomaly detection and downstream event reporting to reduce false positive rates while maintaining responsiveness.

Upon receiving an initial event report, the Hierarchical Voting Controller 206 instantiates a spatial-temporal trigger window defining geographic boundaries and a time duration for corroboration. The geographic boundaries may be a radius from the reporting sensor, a polygon encompassing a predefined zone, or an adaptive boundary based on expected propagation characteristics of the event type. The time duration may be fixed or dynamically adjusted based on event classification or environmental conditions. The controller applies configurable X-of-Y voting thresholds, with X and Y configurable per event type, per geographic zone, or per operational mode.

The Hierarchical Voting Controller 206 dynamically adjusts the voting threshold X and trigger window duration based on contextual factors including time of day, historical false alarm rate for the zone, and current operational state of equipment in the monitored environment.

The Hierarchical Voting Controller 206 implements cross-modal weighting, wherein agreement between sensors of different modalities carries greater validation weight than same-modality agreement. Cross-modal agreement may be assigned a multiplier that effectively reduces the corroboration count needed to satisfy the X-of-Y threshold. The controller supports temporal integration, wherein sustained anomaly readings from a single sensor accumulate validation credit over time, such that persistent single-sensor detection may satisfy a reduced threshold absent spatial corroboration. Accumulated credit may be subject to a decay function that diminishes during periods of non-detection.

The Hierarchical Voting Controller 206 maintains spatial cluster membership mappings corresponding to the cluster configuration in the edge device's configuration data. When sensor nodes are organized into spatial clusters, the controller applies determination independently per cluster, maintaining separate trigger window states, vote accumulators, and threshold evaluations for each active cluster. Anomaly validation within one cluster proceeds without reference to sensor readings in other clusters, preventing genuine localized anomalies from being diluted by normal readings from distant sensors.

The Hierarchical Voting Controller 206 incorporates peer-to-peer corroboration metadata from the sensor tier. When an pre-screening indicator includes information that one or more neighboring nodes provided preliminary corroboration via short-range communication, the controller assigns the indicator an elevated initial voting weight relative to indicators without peer corroboration. The degree of elevation may vary based on the number of corroborating neighbors or their modality types.

In alternative embodiments, the Hierarchical Voting Controller 206 may be replaced by a Bayesian inference module computing posterior event probabilities based on sensor reliability models, or by a machine-learned classifier trained on historical corroboration patterns.

The Training Distribution Analyzer 208 evaluates representativeness of incoming sensor data relative to the distribution used to train the deployed models, identifying coverage gaps that may compromise inference reliability. The subsystem outputs gap metrics to the Novelty Assessment Engine 202.

The Training Distribution Analyzer 208 maintains a compact representation of the training distribution in local memory, which may take the form of cluster centroids from k-means or Gaussian mixture models, parametric descriptors such as mean vectors and covariance matrices, or embedding space boundaries from an encoder network. Upon receipt of new data, the analyzer computes distance metrics—Mahalanobis distance, Euclidean distance to nearest centroids, cosine similarity within embedding spaces, or reconstruction error from autoencoder-based representations—between incoming data and the stored representation. Samples exceeding configurable thresholds are flagged as coverage gaps, and gap metrics including computed distances, nearest distribution region identity, and departure severity scores are transmitted to the Novelty Assessment Engine 202. The representation may be incrementally updated as validated training data becomes available or replaced upon model retraining events.

The Model Patching Engine 210 applies incremental updates to machine learning models in local memory without interrupting ongoing inference operations.

The Model Patching Engine 210 monitors model update trigger conditions to determine when patching should be initiated. The triggers comprise: a scheduled retraining event at a predetermined interval; the model producing confidence scores below a threshold for a predetermined number of consecutive inferences; or accumulation of a threshold number of validated trigger events within a specified period as reported by the Hierarchical Voting Controller 206. When any trigger is satisfied, the engine initiates the applicable update mode.

The Model Patching Engine 210 operates in two modes. A first mode comprises full local retraining during off-peak periods, utilizing locally accumulated data to retrain one or more layers or the entire model. A second mode comprises lightweight delta patching, applying compact parameter differentials directly to weight tensors or bias vectors of the running inference model. Delta patches may be received from the cloud server system, computed locally from recent inference feedback, or derived from aggregation results. The engine merges deltas using element-wise addition or weighted averaging such that inference continues with minimal latency disruption. In one embodiment, deltas are applied per-layer with temporary locking of the target parameters while inference proceeds through other layers. In another embodiment, the engine uses double-buffered parameter storage, writing updated parameters to a secondary buffer and performing a pointer swap upon completion.

Both modes implement a checkpoint-then-patch-then-validate protocol. The engine instructs the Checkpoint and Rollback Manager 212 to serialize the current model state, then applies the update, then executes a validation phase evaluating the updated model against the recent data buffer. If validation indicates degradation, the engine triggers automatic rollback.

In some embodiments, a model executed by the edge computing device may support a deterministic execution mode. When the deterministic execution mode is activated, the edge computing device fixes one or more parameters governing stochastic aspects of model inference, including without limitation a sampling temperature parameter, a top-k sampling cutoff, a top-p (nucleus) sampling cutoff, and one or more pseudo-random seed values used by sampling, dropout, or beam-search components, such that successive inferences performed on identical input data produce identical output. The deterministic execution mode may be invoked selectively—for example, during validation of a newly applied patch against the recent data buffer, during preparation of an inference output that is to be retained for audit or regulatory review, or during certification testing—while permitting non-deterministic operation for ordinary live inference. When the deterministic execution mode is invoked, the edge computing device may further compute a checksum or cryptographic hash of the inference output together with the input data, the model parameter checksum, and the fixed sampling parameters, and may write the resulting checksum to the storage such that the deterministic correspondence between inputs and outputs may be later verified. In alternative embodiments, the deterministic execution mode may be implemented for a model that is not a machine learning model—for example, a deterministic rules-based model in which the deterministic mode is a default and no parameter fixing is required, or a hybrid model in which only the stochastic components are subject to parameter fixing.

The Checkpoint and Rollback Manager 212 provides version control and recovery for deployed models, preserving model integrity across successive patching operations.

The Checkpoint and Rollback Manager 212 serializes the active model state—weights, architecture metadata, hyperparameters, normalization statistics, and pipeline parameters—to non-volatile memory prior to each patching operation. Following patching, the manager monitors post-patch metrics including false positive rate, false negative rate, detection latency, and inference confidence distribution. Upon detecting degradation below a configurable threshold, the manager deserializes the prior checkpoint and restores it to active inference status. The rollback procedure includes logging the event, tagging the failed patch metadata, and notifying the Cloud Synchronization Manager 224. The manager retains at minimum the current and immediately prior model versions. Where sufficient storage is available, additional versions may be retained in a first-in-first-out queue weighted by recorded performance.

The model integrity mechanism implemented by the Model Patching Engine 210 in cooperation with the Checkpoint and Rollback Manager 212 is also referred to herein as a “checkpoint-then-validate-then-restore protocol.” A checkpoint-then-validate-then-restore protocol comprises at least the operations of (a) maintaining, prior to application of an update to the model, a checkpoint of model parameters in a storage; (b) applying the update and validating the updated model against data buffered on the edge computing device; and (c) responsive to a performance metric of the updated model failing to satisfy a stored threshold, restoring the model parameters from the checkpoint. The protocol may further comprise logging the rollback event together with the triggering performance metric value and an identifier of the rejected update, retaining one or more prior checkpoints in a versioned queue, and notifying the Cloud Synchronization Manager 224 of the rollback. The protocol applies equally to updates received from the cloud server system 102 and to local upgrades computed on the edge computing device during periods of constrained, intermittent, or absent connectivity to the cloud server system.

In some embodiments, the edge computing device is configured to maintain an audit log in the storage. For each confirmed trigger event, the edge computing device writes to the audit log an event record comprising at least: an identifier of the trigger event, a timestamp at which the trigger event was confirmed, an identifier of each sensor node that contributed a corroborating pre-screening indicator within the evaluation window, a value of each such pre-screening indicator (for example, a deviation magnitude, a distance metric, a spectral deviation score, or a binary candidate-event flag), an identifier of the determination criterion applied, and the outcome of the determination criterion. For each restoration of model parameters from a checkpoint (a “rollback”), the edge computing device further writes to the audit log a rollback record comprising at least: an identifier of the rejected update, a timestamp of the rollback, at least one performance metric value that triggered the rollback (for example, a measured false positive rate, a measured false negative rate, a measured detection latency, or an inference confidence statistic), the corresponding stored threshold against which the performance metric was compared, and an identifier of the checkpoint to which the model parameters were restored. The audit log may be persisted in the storage and may be transmitted in whole or in part to the remote computing system on a scheduled basis, on demand, or upon the occurrence of a designated reporting event. The foregoing logging facilities support post-hoc analysis of system behavior, regulatory or contractual reporting obligations, and supervised refinement of the determination criterion or of the model.

The methods, processes, and functional modules described herein, including without limitation the Novelty Assessment Engine 202, the Sensing Directive Generator 204, the Hierarchical Voting Controller 206, the Training Distribution Analyzer 208, the Model Patching Engine 210, the Checkpoint and Rollback Manager 212, the Multi-Viewpoint Correlation Engine 214, the Frequency-Domain Signal Processor 216, the Distance Metric Comparator 218, the Bandwidth-Aware Transmission Controller 220, the Resource-Aware Workload Partitioning Module 222, and the Cloud Synchronization Manager 224, may be embodied as instructions stored on one or more non-transitory computer-readable media. The non-transitory computer-readable media may comprise any one or more of: a hard disk drive, a solid-state drive, a flash memory device, a read-only memory, a random-access memory, an optical storage medium, a magnetic storage medium, a programmable logic device configured with persistent state, or any other tangible storage medium that stores instructions in a form readable by a processor. When executed by one or more processors of an edge computing device, of a sensor node, of a cloud server system, or of a combination thereof, the instructions cause the corresponding device or devices to perform any one or more of the methods, processes, or functions described herein. References herein to operations performed “by” any of the foregoing functional modules are to be construed as references to operations caused to be performed by the corresponding instructions stored on the non-transitory computer-readable media when those instructions are executed by the corresponding processor or processors.

The Multi-Viewpoint Correlation Engine 214 orchestrates multiple sensor platforms to observe a common physical asset from distinct spatial orientations and synthesizes the observations into a unified representation. When coverage gaps attributable to occlusion from debris, vegetation, weather, or proximate infrastructure are identified, the engine generates coordination directives instructing mobile platforms to reposition to complementary vantage points.

The Multi-Viewpoint Correlation Engine 214 performs a multi-stage pipeline. In a first stage, observations are registered into a common spatial reference frame using SLAM, IMU fusion, or GPS-aided triangulation. In a second stage, occlusion detection logic identifies asset regions for which surface data is absent or degraded. In a third stage, supplementary observation vectors—azimuth, elevation, and range relative to the asset—predicted to resolve the occlusion are computed and transmitted as directives to mobile platforms. In a fourth stage, temporal fusion correlates current observations with historical data from prior passes at different angles, enabling reconstruction of regions partially occluded in any single pass.

The Multi-Viewpoint Correlation Engine 214 maintains a viewpoint coverage map for each inspected asset, encoding observed surface regions, observation angles, resolution, and confidence. The coverage map is progressively updated and serves as the basis for directive generation and completeness assessment. Fusion output may take the form of a three-dimensional mesh, a textured point cloud, or registered two-dimensional mosaics. In alternative embodiments, multi-platform coordination may be replaced by single-platform multi-pass strategies achieving equivalent angular diversity through computed waypoint sequences. Alternative fusion methodologies include neural radiance field reconstruction, multi-view stereo algorithms, or structure-from-motion pipelines.

The Frequency-Domain Signal Processor 216 executes on processors at sensor nodes, the edge computing device, or both. It receives time-domain sensor signals—vibration data, acoustic waveforms, electromagnetic readings—and converts them into frequency-domain representations for anomaly detection.

The Frequency-Domain Signal Processor 216 applies Fast Fourier Transform algorithms and spectral decomposition including Short-Time Fourier Transform or power spectral density estimation via Welch's method. A windowing stage applies Hamming, Hanning, or Blackman windows to mitigate spectral leakage. Resulting spectral signatures are compared against stored reference spectra using Mahalanobis distance, spectral angle divergence, or Kullback-Leibler divergence. Deviations exceeding thresholds trigger anomaly signals propagated to the Hierarchical Voting Controller 206. In alternative embodiments, the processor may employ Discrete Wavelet Transform or Hilbert-Huang Transform.

The Distance Metric Comparator 218 quantifies similarity or dissimilarity between current sensor data windows and stored reference signatures representing normal-operation conditions. The subsystem maintains reference signature datasets in memory against which incoming data is continuously evaluated.

When a computed distance exceeds its threshold, the Distance Metric Comparator 218 generates an anomaly flag containing triggering metric identity, deviation magnitude, timestamp, and originating sensor channel, propagated to the Hierarchical Voting Controller 206. The subsystem implements multiple computation engines: Hamming distance for binary-encoded representations tallying differing bit positions; cosine similarity for vector-space representations computing directional alignment; and Mahalanobis distance for multivariate comparisons incorporating an inverse covariance matrix to account for inter-feature correlations. In alternative embodiments, the comparator may employ dynamic time warping distance for temporal alignment variations, or learned distance functions from Siamese network architectures wherein the metric is parameterized by trained weights.

The Bandwidth-Aware Transmission Controller 220 governs adaptive data transmission from individual sensor nodes to the edge computing device. The controller mediates between local signal processing and the communication interface, determining volume, format, and timing of transmissions based on detected conditions and real-time bandwidth availability. In its default state, the controller transmits compressed summaries or extracted feature vectors, conserving bandwidth during nominal operation.

Upon receiving an anomaly indication, the controller transitions to full data burst mode, transmitting raw sensor data for a configurable temporal window encompassing data before, during, and after the anomaly. The controller monitors available bandwidth through channel sensing or throughput estimation and dynamically adjusts packet size, rate, and queuing priority. In alternative embodiments, the controller may implement a priority-queuing mechanism transmitting highest-relevance anomaly data first under limited bandwidth.

The Resource-Aware Workload Partitioning Module 222 governs allocation of analytical tasks between local execution on the edge computing device and offloading to the cloud server system 102. The module evaluates a plurality of resource factors to determine in real time whether a given task—such as event classification, event characterization, or model inference—should execute locally or be transmitted to the cloud. The resource factors include current processing load on the edge computing device, available bandwidth on the link to the cloud server system, expected round-trip latency for cloud processing, and energy consumption constraints applicable to the edge computing device or sensor nodes under its management. The resource factors may further include time-varying energy costs reflecting commodity grid pricing, renewable energy availability, or carbon credit considerations applicable to the deployment; peak versus off-peak bandwidth pricing on metered network links; amortized physical infrastructure costs for compute resources at each tier; and cloud-to-cloud data migration costs when the cloud server system spans multiple geographic regions or providers. The module may also evaluate whether non-time-critical analytical tasks can be deferred to off-peak compute windows where processing costs are lower, while ensuring that time-sensitive tasks such as event classification for confirmed events are processed immediately regardless of cost. The module maintains a task queue and applies a partitioning policy that may be rule-based, threshold-based, or learned from historical task execution outcomes. In alternative embodiments, the partitioning policy may incorporate predictive models forecasting near-term bandwidth or load changes to enable preemptive task allocation.

In some embodiments, the resource factors evaluated by the Resource-Aware Workload Partitioning Module 222 are characterized as configured factors or as measured factors. A configured factor is one whose value is set in the configuration data of the edge computing device 104 and is available to the partitioning module without runtime measurement, including without limitation a configured round-trip latency budget applicable to a class of analytical task, a configured energy constraint applicable to the edge computing device or to one or more sensor nodes under its management, and a configured bandwidth ceiling applicable to a network interface. A measured factor is one whose value is sampled or computed by the partitioning module at or near the time of the partitioning decision, including without limitation a measured processing load on the edge computing device, a measured throughput on the link to the cloud server system, and a measured transmit-queue depth. The partitioning policy applied by the module may use any combination of configured factors and measured factors, such that the policy may be evaluated using configuration data alone where runtime measurements are unavailable, using runtime measurements alone where configuration data does not specify the relevant factor, or using a combination of both.

The Cloud Synchronization Manager 224 manages bidirectional exchange of event data, model parameter deltas, and model artifacts between the edge computing device and the cloud server system 102. In the upward direction, the manager assembles validated event records—comprising sensor data, timestamps, validation metadata, and contributing sensor identifiers—and model parameter deltas from the Model Patching Engine 210. The manager transmits only validated records and deltas, not raw sensor streams. The manager may batch records for periodic transmission, prioritize higher-severity events, or persist data locally for transmission when connectivity becomes available.

Aggregated determinations. References herein and in the appended claims to “aggregated determinations,” “aggregated data,” or “information aggregated from the plurality of edge computing devices” are to be construed broadly to encompass any one or more of: validated event records produced by the Hierarchical Voting Controller 206, parameter changes (including parameter deltas, gradient updates, weight tensor changes, and weight tensor differentials) produced by the Model Patching Engine 210, inference outputs and confidence statistics, audit log entries, novelty score histories, and any other data communicated from the edge computing device 104 to the cloud server system 102, and combinations thereof. The Cloud Synchronization Manager 224 is configured to package and transmit any combination of the foregoing in a single communication or in separate communications, and the cloud server system 102 is configured to aggregate the received determinations across the plurality of edge computing devices to produce the updated global model.

In the downward direction, the Cloud Synchronization Manager 224 receives updated global models from the cloud server system, stores them in a staging area, verifies integrity via hash-based checks, and initiates the checkpoint-then-patch-then-validate protocol through the Checkpoint and Rollback Manager 212 and Model Patching Engine 210. Upon successful validation the manager confirms deployment to the cloud; upon failure and rollback it transmits a diagnostic report identifying the triggering metrics. In alternative embodiments, the manager may implement a canary deployment activating the updated model for a subset of inference requests while the prior model serves the remainder, with full activation after satisfactory performance over a configurable observation period.

In some embodiments, the edge computing device is configured to compute and apply local model upgrades during periods of constrained, intermittent, or absent connectivity to the remote computing system. During such periods, the Model Patching Engine 210 derives a local model upgrade from event records generated locally by the edge computing device since a last successful upload, applies the local upgrade subject to the same checkpoint-then-patch-then-validate protocol described elsewhere herein, and, upon successful local validation, deploys the locally upgraded model for ongoing inference. The Cloud Synchronization Manager 224 retains parameter changes representative of the locally derived upgrade and any event records not yet uploaded in a persistent transmission queue, and, upon restoration of connectivity to the remote computing system, transmits the queued parameter changes and event records to the remote computing system for aggregation. Where multiple local upgrades have been applied during the period of constrained connectivity, the Cloud Synchronization Manager 224 may transmit a consolidated parameter change representing the cumulative effect of the local upgrades or, in alternative embodiments, transmit each local upgrade in sequence with associated metadata indicating the order of application. The deferred-upload mode enables continuous on-device improvement of the model without dependence on continuous wide-area network connectivity, and is particularly applicable to deployments in remote, mobile, or otherwise bandwidth-limited environments.

### Computer Implemented Process

The process steps described herein may be performed in association with a system such as that described in FIG. 1 and/or FIG. 2 above or in association with a different system. The process may comprise additional steps, fewer steps, and/or a different order of steps without departing from the scope of the invention as would be apparent to one of ordinary skill in the art.

### Computer Implemented Process—Sensing, Detection, and Event Validation

The process steps described herein may be performed in association with the system of FIG. 1 and/or FIG. 2 or a different system. The process may comprise additional steps, fewer steps, and/or a different order of steps without departing from the scope of the invention.

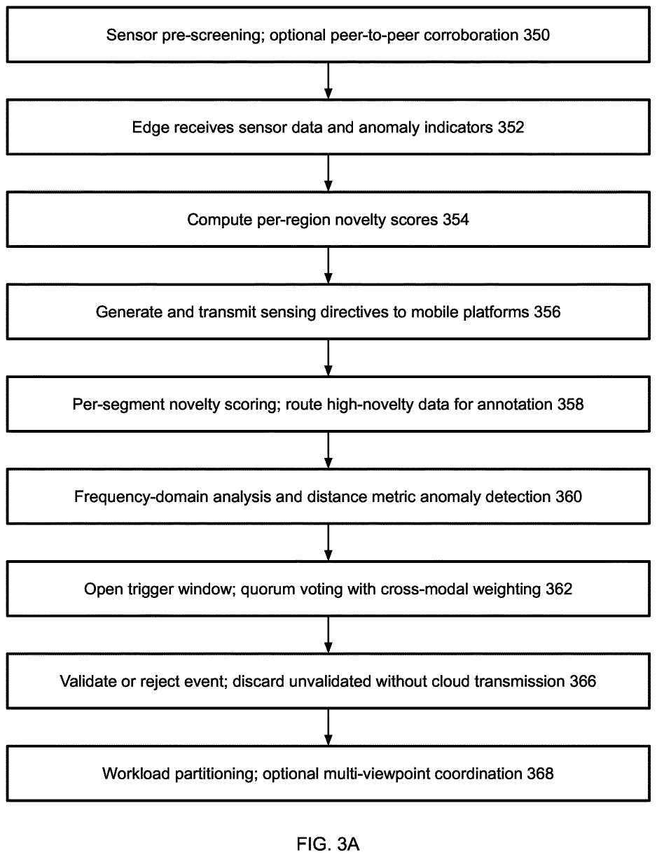

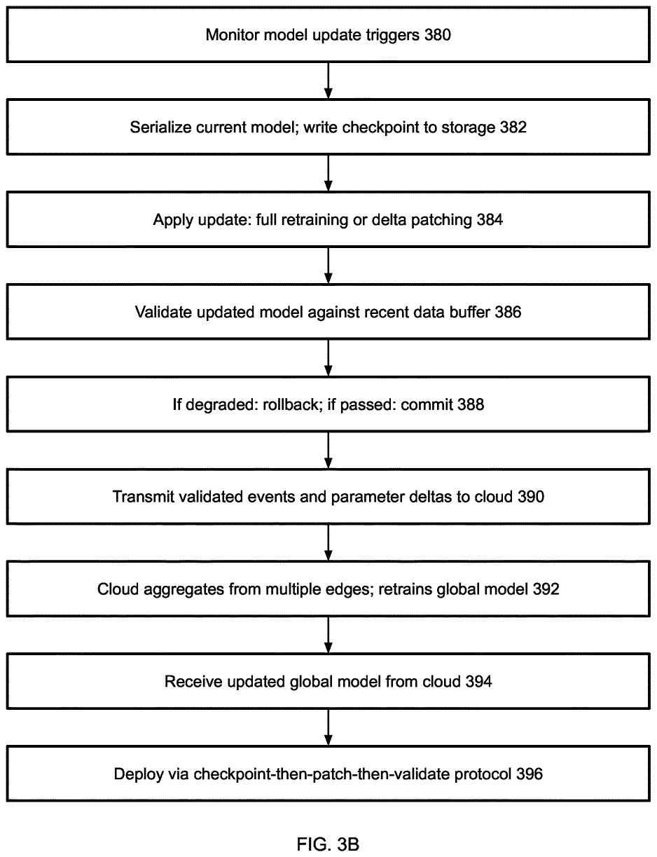

FIG. 3A illustrates a continuous sensing, detection, and event validation loop executed by the edge computing device 104 in coordination with the sensor tier. The loop runs in real time during active monitoring operations and governs how data is collected, screened, assessed for novelty, and validated through multi-sensor corroboration.

At 350, one or more sensor nodes in the sensor tier detect a event anomaly through local anomaly pre-screening. The local processing unit of the sensor node transforms incoming sensor data into a frequency-domain representation and/or computes a distance metric between the current data pattern and a stored normal-operation reference signature. When the frequency-domain analysis reveals an anomalous spectral pattern or the computed distance metric exceeds a configured threshold, the sensor node generates a candidate pre-screening indicator. In embodiments supporting peer-to-peer preliminary validation, the sensor node broadcasts a short-range alert (also referred to herein as a wireless inter-node alert) to neighboring sensor nodes within communication range. Neighboring nodes evaluate their own recent readings for corroborating evidence and respond with an indication of whether corroboration was observed. The originating sensor node packages the candidate pre-screening indicator together with metadata indicating sensor identity, geographic location, timestamp, modality type, and—where peer-to-peer validation was performed—whether any neighboring nodes provided preliminary corroboration. The packaged indicator is transmitted to the edge computing device 104. During nominal operation when no anomaly is detected, the sensor node transmits only compressed summaries or extracted feature vectors to conserve bandwidth.

At 352, the processor of the edge computing device receives, via the network interface, sensor data streams and pre-screening indicators from the plurality of sensor nodes. The processor stores the received data in a data buffer in memory. The data buffer retains a rolling window of recent data used for both novelty assessment and post-event analysis.

At 354, the processor executes the Novelty Assessment Engine 202 to compute a per-region novelty score for each region of the monitored environment. The processor integrates at least two of three input signal types: anomaly model outputs indicating deviation magnitudes from an anomaly detection module, training distribution gap metrics from the Training Distribution Analyzer 208 indicating statistical distance between incoming data and the model's training distribution, and external contextual data retrieved via the external data source interface 110. The processor applies weighted combination functions stored in memory to generate composite per-region scores. The processor applies a temporal decay adjustment increasing scores for regions with stale observations and suppressing scores for recently observed regions. The processor applies the exploration ratio to ensure a minimum fraction of sensing attention is allocated to low-novelty regions.

At 356, the processor executes the Sensing Directive Generator 204 to transform the per-region novelty scores into sensing directives. The directives may comprise modified flight paths with waypoint sequences prioritizing high-novelty regions, priority queues ranking locations by novelty score, or sampling schedules specifying increased collection frequency for high-novelty regions. The processor transmits the directives via the network interface to one or more mobile sensor platforms, causing the platforms to physically reposition and adjust data collection behavior to prioritize high-novelty regions over low-novelty regions.

At 358, the processor evaluates data segments returned by the mobile sensor platforms following execution of the sensing directives. The processor computes a per-segment novelty score for each captured data segment by evaluating the segment against training distribution gap metrics from the Training Distribution Analyzer 208. Segments whose per-segment novelty scores exceed a configurable annotation threshold are routed to a human annotation queue for manual labeling. Segments below the threshold are auto-labeled using the current model's inference output or discarded. This selective routing concentrates human annotation effort on data with the highest expected contribution to model improvement.

At 360, the processor applies anomaly detection to the incoming sensor data streams. The processor executes the Frequency-Domain Signal Processor 216 to transform time-domain signals into frequency-domain representations using Fast Fourier Transform and spectral decomposition, identifying frequency-based anomaly signatures. The processor executes the Distance Metric Comparator 218 to compute Hamming distance, cosine similarity, or Mahalanobis distance between current data windows and stored normal-operation reference signatures. When frequency-based signatures or distance metric values exceed configured deviation thresholds, the processor generates a trigger event indication.

At 362, responsive to the trigger event indication, the processor executes the Hierarchical Voting Controller 206 to open a spatial-temporal trigger window. The processor retrieves trigger window parameters from configuration data stored in memory, the parameters defining geographic boundaries specifying a spatial extent around the triggering sensor location and a time duration specifying how long the window remains open. The processor dynamically adjusts the geographic boundaries, time duration, and voting threshold based on contextual factors including event type, sensor density in the surrounding area, time of day, historical false alarm rate for the zone, and current operational state of equipment in the monitored environment. When sensor nodes are organized into spatial clusters, the processor scopes the trigger window to the cluster containing the triggering sensor, applying the determination independently for that cluster without reference to sensors in other clusters.

At 364, during the open trigger window, the processor monitors for corroborating pre-screening indicators from additional sensor nodes within the window boundaries. The processor applies the determination criterion requiring that at least X of Y eligible sensors report corroborating indicators. The processor applies cross-modal weighting such that agreement between sensors of different modalities contributes greater validation weight than same-modality agreement. The processor applies temporal integration such that sustained readings from a single sensor accumulate validation credit equivalent to multi-sensor corroboration by a configurable factor. Where pre-screening indicators include peer-to-peer corroboration metadata from the sensor tier, the processor assigns elevated initial voting weight to those indicators relative to indicators transmitted without peer corroboration.

At 366, the processor determines whether the accumulated voting weight meets or exceeds the validation threshold. If the threshold is met, the processor marks the event as a confirmed trigger event. If the threshold is not met upon expiration of the trigger window, the processor rejects the event, discarding or archiving the associated data locally without cloud transmission, thereby conserving bandwidth. The processor logs the validation decision, contributing sensor reports, and associated metadata to non-volatile storage for audit purposes.

At 368, for confirmed trigger events, the processor executes the Resource-Aware Workload Partitioning Module 222 to determine whether further analysis should be performed locally on the edge computing device or offloaded to the cloud server system. The module evaluates current processing load, available cloud link bandwidth, expected round-trip latency, and energy constraints, and routes the confirmed event accordingly. The processor may additionally classify or characterize the anomaly using the locally-deployed machine learning model.

At 370, for confirmed events where observations of the relevant asset exhibit partial occlusion, the processor executes the Multi-Viewpoint Correlation Engine 214. The processor identifies occluded surface regions of the target asset, computes supplementary observation vectors predicted to resolve the occlusion, and transmits coordination directives to one or more mobile sensor platforms instructing repositioning to complementary vantage points. Observations from the diverse orientations are fused with historical observation data to generate a composite asset representation with reduced occlusion. Step 370 is optional and is invoked only when the system determines that occlusion is degrading detection confidence for a specific asset.

Upon completion of steps 366 through 370, the process returns to step 352 to continue receiving and processing incoming sensor data, forming a continuous loop. Confirmed events and their associated data are made available to the model update and cloud synchronization cycle described in connection with FIG. 3B.

### Computer Implemented Process—Model Update and Cloud Synchronization

FIG. 3B illustrates a model update and cloud synchronization cycle executed by the edge computing device 104. Unlike the continuous real-time loop of FIG. 3A, this cycle runs periodically or in response to trigger conditions, and governs how locally-deployed machine learning models are maintained, improved, and synchronized with the cloud server system 102. The connection between FIG. 3A and FIG. 3B is that the continuous sensing loop of FIG. 3A produces validated trigger events and inference confidence data that feed into the trigger evaluation of FIG. 3B.

At 380, the processor monitors model update trigger conditions to determine whether the locally-deployed machine learning model requires updating. The processor evaluates three categories of trigger conditions. A first trigger condition comprises a scheduled retraining event occurring at a predetermined time or interval maintained in a scheduling table stored in the configuration data. A second trigger condition comprises the locally-deployed machine learning model producing inference confidence scores below a configurable confidence threshold for a predetermined number of consecutive inferences, as tracked by a confidence monitoring component of the Model Patching Engine 210, indicating sustained degradation of model performance. A third trigger condition comprises the edge computing device accumulating a threshold number of validated trigger events within a specified period, as reported by the Hierarchical Voting Controller 206 during execution of the FIG. 3A loop, indicating that the operational environment has shifted sufficiently to warrant model revision. The processor remains in the monitoring state at step 380 until at least one trigger condition is satisfied, at which point the processor proceeds to step 382.

At 382, prior to applying any model update, the processor executes the Checkpoint and Rollback Manager 212 to preserve the current model state. The processor serializes the current machine learning model parameters—including weight matrices, bias vectors, normalization statistics, hyperparameter configurations, and associated inference pipeline parameters—and writes the serialized checkpoint to non-volatile storage with an associated version identifier and timestamp. The version identifier uniquely distinguishes this checkpoint from other checkpoints stored on the device. The checkpoint ensures a deterministic recovery path that does not require cloud connectivity, re-downloading a prior model, or human intervention.

At 384, the processor executes the Model Patching Engine 210 to apply a model update in one of two modes. In a first mode applicable during off-peak periods, the processor performs full local retraining using locally accumulated training data, including validated trigger event data and annotation results received via the FIG. 3A loop, to retrain one or more layers or the entirety of the locally-stored model. In a second mode, the processor applies lightweight delta patching by receiving or computing compact parameter differentials and applying them directly to weight tensors and bias vectors of the running inference model using element-wise addition or weighted averaging. The delta patches may be computed locally based on recent inference feedback or received from the cloud server system 102. In both modes, the model remains available for concurrent inference requests throughout the update. In one embodiment, deltas are applied per-layer with temporary locking of the target parameters while inference proceeds through other layers. In another embodiment, the processor uses double-buffered parameter storage, writing updated parameters to a secondary buffer and performing a pointer swap upon completion.

At 386, the processor validates performance of the updated model against recent operational data. The processor retrieves sensor data from the recent data buffer—a sliding window of recently collected data representative of current operating conditions—and executes inference using the updated model. The processor computes performance metrics including false positive rate, false negative rate, detection latency, and inference confidence distribution, and compares each metric against corresponding baseline thresholds stored in the configuration data. The processor generates a validation result indicating whether the updated model meets performance requirements.

At 388, the processor evaluates the validation result. If any performance metric has degraded below its baseline threshold, the processor executes an automated rollback by retrieving the serialized checkpoint created at step 382 from non-volatile storage, deserializing the checkpoint, and restoring the prior model parameters to active inference status. The processor logs the rollback event including the specific metrics that triggered the rollback, the identity of the rejected update, and the checkpoint version to which the system reverted. The rollback is performed autonomously without requiring communication with the cloud server system or human intervention. If all performance metrics meet or exceed their baseline thresholds, the processor commits the updated model as the active inference model and optionally updates the stored checkpoint in non-volatile storage to reflect the newly validated model state, such that subsequent rollback operations would revert to this updated state. The processor logs the successful update event capturing the performance metrics that confirmed acceptable behavior.

At 390, the processor executes the Cloud Synchronization Manager 224 to transmit validated event data and model parameter deltas to the cloud server system 102. The processor assembles validated event records produced during the FIG. 3A loop into structured packages comprising sensor data captured during each event, detection and validation timestamps, validation metadata describing voting outcome and confidence level, and identifiers of contributing sensor nodes. The processor further packages model parameter deltas representing the incremental difference between the prior model state and the current updated model state. The processor transmits only validated records and parameter deltas, not raw sensor streams. The processor may batch multiple records for periodic transmission, prioritize higher-severity events for immediate transmission, or persist data locally using a store-and-forward mechanism for transmission when cloud connectivity becomes available.

At 392, the cloud server system 102 aggregates parameter deltas and event data received from the edge computing device 104 together with data received from one or more additional edge computing devices across the distributed monitoring network. The global model training engine of the cloud server system retrains one or more machine learning models using the aggregated dataset, validates the retrained models against held-out test data, and upon successful validation assigns a version identifier to the updated global model and stores it in the model repository alongside prior versions.

At 394, the processor of the edge computing device receives an updated global model from the cloud server system 102 via the wide-area network interface. The Cloud Synchronization Manager 224 stores the received model in a staging area in non-volatile storage and verifies integrity via hash-based checks. The processor then executes the checkpoint-then-patch-then-validate protocol: the Checkpoint and Rollback Manager 212 serializes the current active model state, the Model Patching Engine 210 applies the received global model, and the processor validates the deployed global model against the recent data buffer using the same performance metrics and baseline thresholds described at step 386. If validation succeeds, the processor activates the global model for inference and transmits a deployment acknowledgment to the cloud server system. If validation fails, the processor rolls back to the prior checkpoint, transmits a diagnostic report to the cloud server system identifying the metrics that triggered the rollback, and continues operating on the prior model. The edge computing device retains the prior model version in non-volatile storage regardless of validation outcome, ensuring rollback capability is always available.

Upon completion of step 394, the process returns to step 380 to continue monitoring trigger conditions, forming a recurring cycle. The model update and cloud synchronization cycle operates concurrently with and independently of the sensing, detection, and event validation loop of FIG. 3A, such that ongoing monitoring operations are not interrupted by model maintenance activities.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

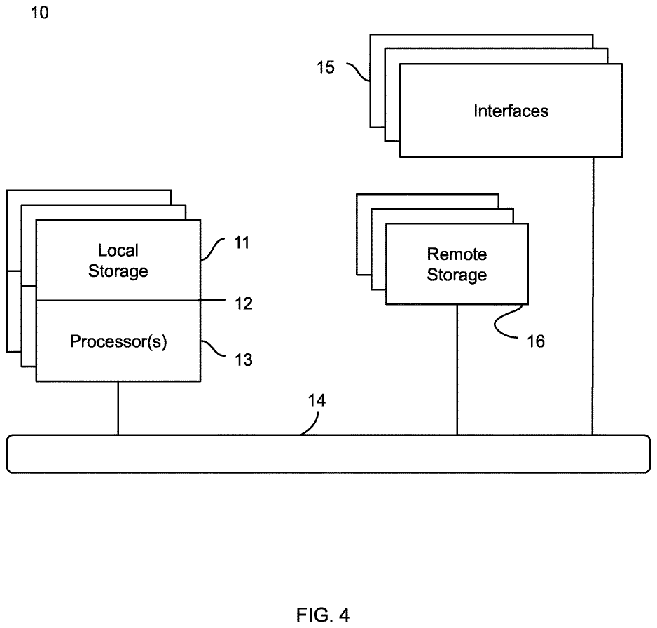

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments). Any of the above mentioned systems, units, modules, engines, controllers, components, process steps or the like may be and/or comprise hardware and/or software as described herein. For example, the systems, engines, and subcomponents described herein may be and/or comprise computing hardware and/or software as described herein in association with FIGS. 4-7. Furthermore, any of the above mentioned systems, units, modules, engines, controllers, components, interfaces or the like may use and/or comprise an application programming interface (API) for communicating with other systems units, modules, engines, controllers, components, interfaces or the like for obtaining and/or providing data or information.

Referring now to FIG. 4, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 4 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

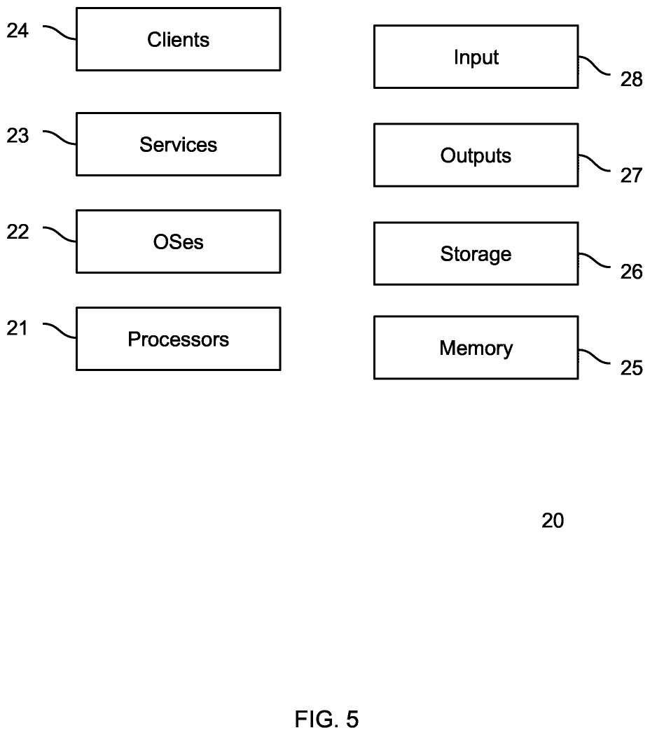

In some embodiments, systems may be implemented on a standalone computing system. Referring now to FIG. 5, there is shown a block diagram depicting a typical exemplary architecture of one or more embodiments or components thereof on a standalone computing system. Computing device 20 includes processors 21 that may run software that carry out one or more functions or applications of embodiments, such as for example a client application. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 4). Examples of storage devices 26 include flash memory, magnetic hard drive, CD-ROM, and/or the like.

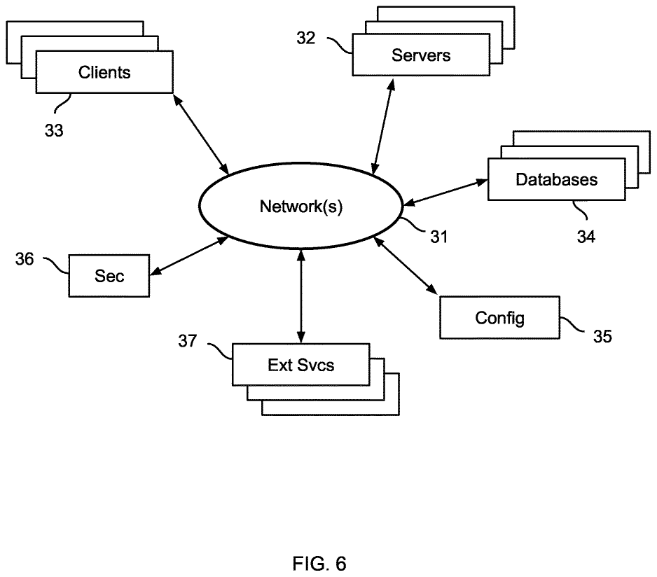

In some embodiments, systems may be implemented on a distributed computing network, such as one having any number of clients and/or servers. Referring now to FIG. 6, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 5. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications are implemented on a smartphone or other electronic device, client applications may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

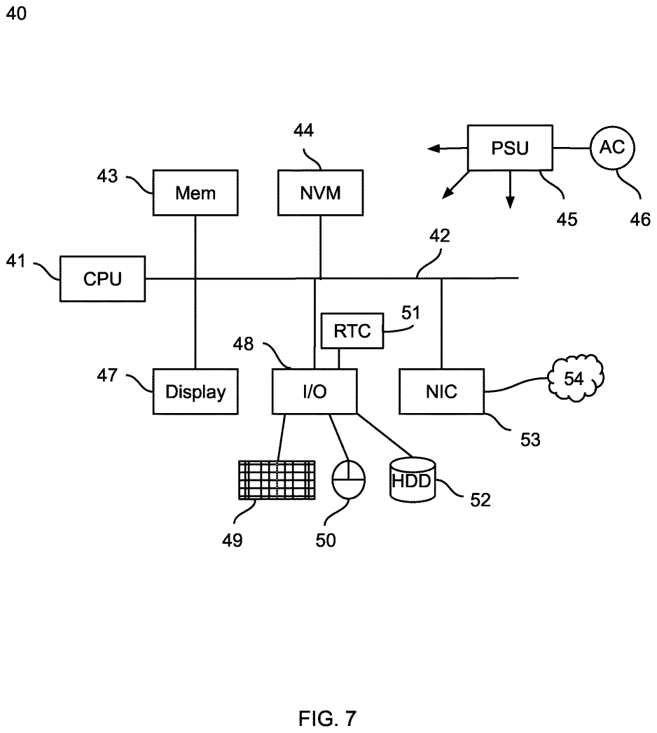

FIG. 7 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

### ADDITIONAL CONSIDERATIONS

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and/or a process associated with the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A system, comprising:
a plurality of edge computing nodes, wherein at least a first edge computing node of the plurality of edge computing nodes comprises a local processing unit and is communicatively coupled to at least one sensor; and
a remote computing system communicatively coupled to the plurality of edge computing nodes;
wherein the first edge computing node is configured to:
receive sensor data from the at least one sensor;
make a local determination of an event based on the received sensor data using a local analytical model;
transmit information related to the local determination to the remote computing system;
receive an updated local instance of the analytical model from the remote computing system, the updated local instance based at least in part on aggregated determinations from the plurality of edge computing nodes; and
apply the updated local instance for subsequent event determinations.

2. The system of claim 1, wherein the first edge computing node is further configured to:
compute a per-region novelty score for each of a plurality of regions of a monitored environment by integrating at least two of (i) an output of an anomaly detection module indicating deviation from a previously characterized pattern, (ii) a metric indicating a statistical distance between sensor data received from the region and a stored representation of a training distribution of the local analytical model, and (iii) contextual data received from a data source external to the first edge computing node;
transmit a sensing directive to at least one sensor based on the per-region novelty scores, the sensing directive causing the at least one sensor to physically reposition to prioritize data collection in a region having a higher per-region novelty score over a region having a lower per-region novelty score;
apply a determination criterion to corroborating pre-screening indicators received from two or more sensors within an evaluation window before confirming the event, the determination criterion requiring that a configured threshold number of sensors report corroborating pre-screening indicators within the evaluation window; and
prior to applying the updated local instance of the analytical model, maintain a checkpoint of analytical model parameters, validate the updated local instance against data buffered on the first edge computing node, and, responsive to a performance metric of the updated local instance failing to satisfy a stored threshold, restore the analytical model parameters from the checkpoint.

3. The system of claim 1, wherein the first edge computing node is further configured to compute a per-region novelty score for each of a plurality of regions of a monitored environment and to transmit a sensing directive based on the per-region novelty scores to the at least one sensor, the sensing directive causing the at least one sensor to physically reposition to prioritize data collection in a region having a higher per-region novelty score over a region having a lower per-region novelty score.

4. The system of claim 1, wherein the local determination of the event comprises applying a determination criterion to corroborating pre-screening indicators received from two or more sensors within an evaluation window, the determination criterion requiring that a configured threshold number of sensors report corroborating pre-screening indicators within the evaluation window before the event is confirmed.

5. The system of claim 1, wherein the first edge computing node is further configured to maintain a checkpoint of analytical model parameters prior to applying the updated local instance of the analytical model, to validate the updated local instance against data buffered on the first edge computing node, and, responsive to a performance metric of the updated local instance failing to satisfy a stored threshold, to restore the analytical model parameters from the checkpoint.

6. The system of claim 4, wherein the determination criterion further comprises a weighting that assigns greater validation weight to corroboration between sensors whose sensing modalities differ in at least one of physical principle of transduction, operational frequency band, or sensed measurand, than to corroboration between sensors whose sensing modalities are identical in each of those characteristics.

7. The system of claim 1, wherein the first edge computing node is configured to identify a candidate event when a sensed condition that would not constitute a candidate event during a stored expected time window associated with the sensed condition is observed outside the stored expected time window.

8. The system of claim 1, wherein the at least one sensor is configured to acquire sensor data spanning two or more wavelength bands and the local processing unit is configured to compute a spectral signature from the sensor data and to identify a candidate event when a deviation between the spectral signature and a stored reference spectral signature exceeds a stored threshold.

9. The system of claim 1, wherein the local analytical model is configured to operate in a deterministic execution mode in which one or more of a sampling temperature parameter and a pseudo-random seed value are fixed such that successive inferences over identical input data produce identical output, and wherein the first edge computing node is configured to log a checksum of an inference output generated in the deterministic execution mode together with an identifier of the corresponding input data.

10. The system of claim 1, wherein the first edge computing node comprises a resource-aware workload partitioning module configured to assign a given analytical task either to local execution by the local processing unit or to transmission to the remote computing system for execution, the assignment being made as a function of at least two of: a measured processing load on the first edge computing node, a measured or configured bandwidth associated with a network interface of the first edge computing node, a configured round-trip latency budget applicable to the analytical task, and a configured energy constraint applicable to the first edge computing node or to the at least one sensor.

11. A method, comprising:
receiving, at a first edge computing node of a plurality of distributed edge computing nodes, sensor data from at least one communicatively coupled sensor;
processing the sensor data using a local analytical model executing on the first edge computing node to detect an event condition;
transmitting data representing the detected event condition to a remote computing system;
receiving, from the remote computing system, an updated local analytical model, wherein the updated local analytical model is generated by the remote computing system based on data aggregated from the plurality of distributed edge computing nodes; and
executing the updated local analytical model on the first edge computing node.

12. The method of claim 11, further comprising:
computing, by the first edge computing node, a per-region novelty score for each of a plurality of regions of a monitored environment by integrating at least two of (i) an output of an anomaly detection module indicating deviation from a previously characterized pattern, (ii) a metric indicating a statistical distance between sensor data received from the region and a stored representation of a training distribution of the local analytical model, and (iii) contextual data received from a data source external to the first edge computing node;
transmitting, by the first edge computing node, a sensing directive based on the per-region novelty scores, the sensing directive causing physical repositioning of the at least one sensor to prioritize data collection in a region having a higher per-region novelty score over a region having a lower per-region novelty score;
applying, by the first edge computing node, a determination criterion to corroborating pre-screening indicators received from two or more sensors within an evaluation window before confirming the event condition, the determination criterion requiring that a configured threshold number of sensors report corroborating pre-screening indicators within the evaluation window; and
prior to executing the updated local analytical model, maintaining a checkpoint of analytical model parameters, validating the updated local analytical model against data buffered on the first edge computing node, and, responsive to a performance metric of the updated local analytical model failing to satisfy a stored threshold, restoring the analytical model parameters from the checkpoint.

13. The method of claim 11, further comprising detecting an operational failure or performance degradation associated with the updated local analytical model, and executing a rollback mechanism to revert the first edge computing node to a previous version of the local analytical model based on a localized checkpoint.

14. The method of claim 11, further comprising, during a period of constrained or absent connectivity to the remote computing system, computing a local upgrade to the local analytical model on the first edge computing node based on event conditions detected locally by the first edge computing node, applying the local upgrade subject to a checkpoint-then-validate-then-restore protocol, and deferring transmission of parameter changes representative of the local upgrade to the remote computing system until connectivity is restored.

15. The method of claim 11, further comprising corroborating the detected event condition through at least one of: a cross-modal comparison of sensor data from a first sensor having a first modality type and a second sensor having a second, different modality type, and an intra-modal comparison of sensor data from two or more sensors of a same modality type.

16. A non-transitory computer-readable medium storing instructions that, when executed by one or more processors of an edge computing node, cause the edge computing node to:
receive sensor data from at least one sensor;
make a local determination of an event based on the received sensor data using a local analytical model;
transmit information related to the local determination to a remote computing system;
receive an updated local instance of the analytical model from the remote computing system, the updated local instance based at least in part on aggregated determinations from a plurality of edge computing nodes; and
apply the updated local instance for subsequent event determinations.

17. The non-transitory computer-readable medium of claim 16, wherein the instructions further cause the edge computing node to:
compute a per-region novelty score for each of a plurality of regions of a monitored environment by integrating at least two of (i) an output of an anomaly detection module indicating deviation from a previously characterized pattern, (ii) a metric indicating a statistical distance between sensor data received from the region and a stored representation of a training distribution of the local analytical model, and (iii) contextual data received from a data source external to the edge computing node;
transmit a sensing directive to at least one sensor based on the per-region novelty scores, the sensing directive causing the at least one sensor to physically reposition to prioritize data collection in a region having a higher per-region novelty score over a region having a lower per-region novelty score;
apply a determination criterion to corroborating pre-screening indicators received from two or more sensors within an evaluation window before confirming the event, the determination criterion requiring that a configured threshold number of sensors report corroborating pre-screening indicators within the evaluation window; and
prior to applying the updated local instance of the analytical model, maintain a checkpoint of analytical model parameters, validate the updated local instance against data buffered on the edge computing node, and, responsive to a performance metric of the updated local instance failing to satisfy a stored threshold, restore the analytical model parameters from the checkpoint.

18. The non-transitory computer-readable medium of claim 16, wherein the local determination of the event comprises applying a determination criterion comprising a weighting that assigns greater validation weight to corroboration between sensors whose sensing modalities differ in at least one of physical principle of transduction, operational frequency band, or sensed measurand than to corroboration between sensors whose sensing modalities are identical in each of those characteristics.

19. The non-transitory computer-readable medium of claim 16, wherein the instructions further cause the edge computing node to operate the local analytical model in a deterministic execution mode in which one or more of a sampling temperature parameter and a pseudo-random seed value are fixed such that successive inferences over identical input data produce identical output, and to log a checksum of an inference output generated in the deterministic execution mode together with an identifier of the corresponding input data.

20. The non-transitory computer-readable medium of claim 16, wherein the instructions further cause the edge computing node to coordinate, with one or more additional edge computing nodes of the plurality of edge computing nodes, at least one of: distribution of pre-screening indicators among the edge computing nodes, handoff of sensing directives between the edge computing nodes, and synchronization of analytical model checkpoints across the edge computing nodes, without requiring transit of the pre-screening indicators or the sensing directives through the remote computing system, and wherein the remote computing system comprises a plurality of remote computing nodes distributed across two or more of: distinct geographic regions, distinct ownership domains, distinct cloud service providers, and distinct on-premises facilities.
